(19) United States
(12) Patent Application Publication
(10) Pub. No.: US 2007/0205311 A1
(43) Pub. Date: Sep. 6, 2007

(54) Device for dispensing adhesive

(75) Inventor: Paul Stampfli, Munchenbuchsee (CH)

Correspondence Address: OLIFF & BERRIDGE, PLC, P.O. BOX 19928, ALEXANDRIA, VA, 22320, US

(73) Assignee: SIKA TECHNOLOGY AG, Zurich (CH)

(21) Appl. No.: 11/516,543

(22) Filed: Sep. 7, 2006

Related U.S. Application Data
(63) Continuation of application No. 10/542,773, now abandoned.

(30) Foreign Application Priority Data
Jan. 20, 2003 (EP) 03405022.9
Sep. 23, 2003 (EP) 03045693.7

(51) Int. Cl. A62C 31/02

(52) U.S. Cl. 239/589; 239/329

(57) ABSTRACT

A device for dispensing adhesive, with at least one adhesive container with an application arrangement arranged at the container outlet, characterized in that the application arrangement comprises an adhesive strip which has a number of dispensing openings.

This is a Continuation of Application No. 10/542,773 filed Jul. 20, 2005, which in turn is a National Phase of Application No. PCT/CH04/000009 filed Jan. 13, 2004.

The present invention relates to a device for dispensing adhesive according to the preamble of patent claim 1. Various devices for dispensing adhesive, which are used above all for dispensing adhesive onto floors for the laying of parquet flooring, are known, these devices having a container for adhesive, which is connected to a dispensing nozzle. When these devices are used, adhesive is conveyed out of the nozzle onto the floor, and it is as a rule necessary to distribute the adhesive by means of a spatula, this work not only being laborious but also leading to work clothes being soiled.

Starting from this known state of the art, it is an object of the present invention to indicate a device for dispensing adhesive which guarantees more efficient application of adhesive to the floor and allows working with this device to be carried out in a way which is not only kinder to joints but also cleaner. A device which achieves this object is indicated in patent claim 1.

In a preferred embodiment, the glue strip of the device is easy to clean, and, in further developments according to dependent claims, the device is environmentally friendly as a very small amount of waste arises.

The invention is explained in greater detail below with reference to drawings of illustrative embodiments, in which:

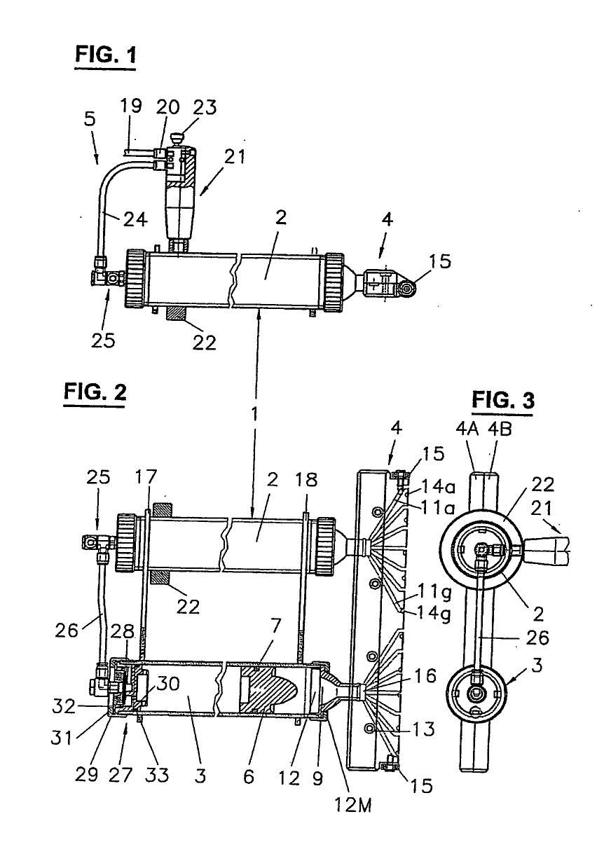

FIG. 1 shows a side view of a first illustrative embodiment of a dispensing device according to the invention;

FIG. 2 shows another side view of the device from FIG. 1;

FIG. 3 shows a view from above of the device from FIG. 1;

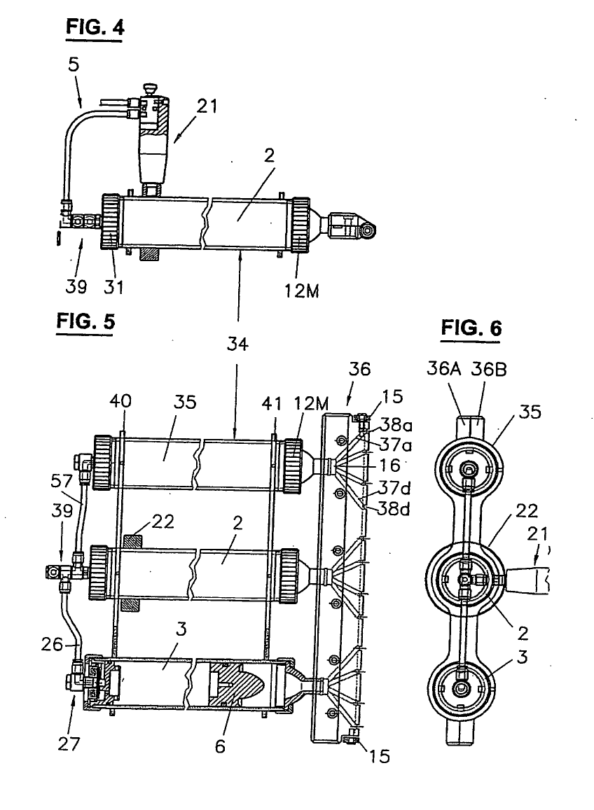

FIG. 4 shows a side view of a second illustrative embodiment of the device according to the invention;

FIG. 5 shows another side view of the device from FIG. 4;

FIG. 6 shows the device from FIG. 4 from above;

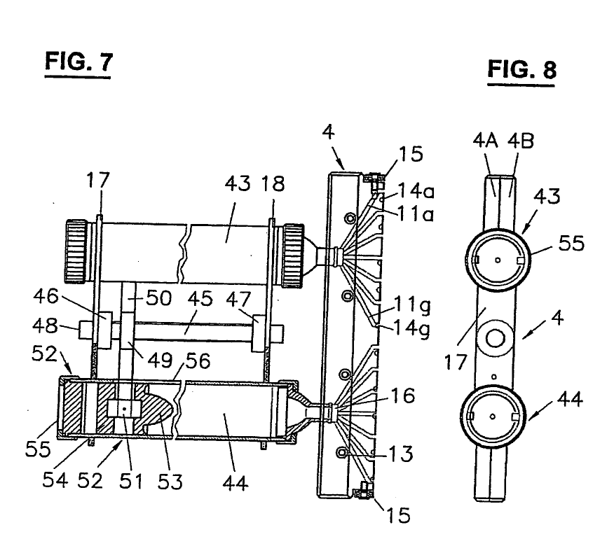

FIG. 7 shows a side view of a further illustrative embodiment of the device according to the invention;

FIG. 8 shows the device from FIG. 7 from above;

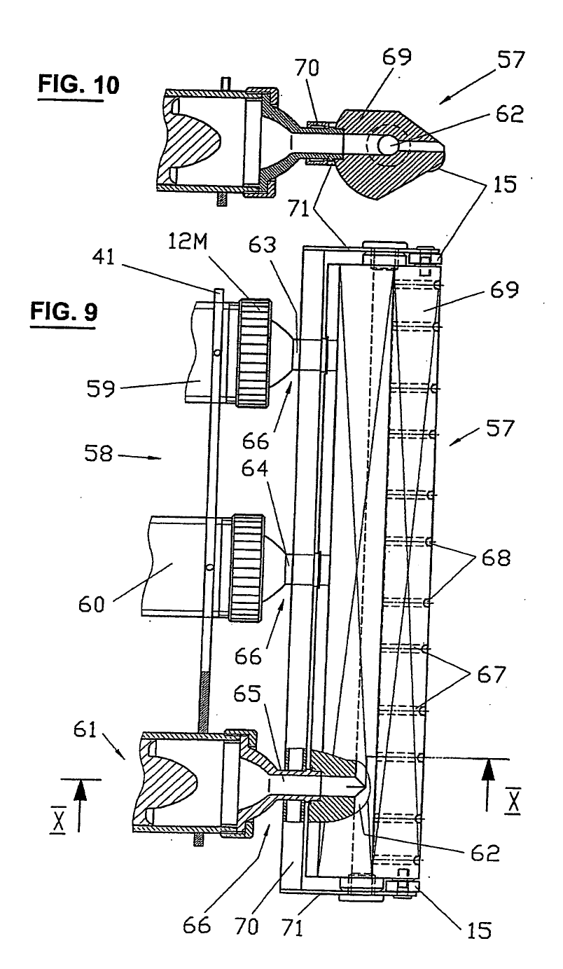

FIG. 9 shows a plan view, partly in section, of a further illustrative embodiment of a device according to the invention, and

FIG. 10 shows a section along the line X-X in FIG. 9.

The first illustrative embodiment, the dispensing device 1, comprises two adhesive cylinders 2 and 3 and also an adhesive strip 4 and a compressed-air supply arrangement 5. The adhesive cylinders 2 and 3 serve to receive adhesive bags (not drawn here) and have, for dispensing, a piston 6, which has a sealing ring 7, in order that the compressed air does not flow off around the piston and thus reduces the pressure, and a nose-shaped front part 8, the shape of which corresponds to the funnel-shaped inlet 9 of the nozzle 10.

Arranged between the cylinder outlet 12 and the adhesive strip is a nozzle 10, which leads to a cavity 16, starting from which ducts 11a-11g are arranged, which end in dispensing openings 14a-14g in the adhesive strip. The cavity 16 ensures that the adhesive is conducted uniformly to all dispensing openings, which makes uniform application possible. The dispensing openings and their mutual spacing are adapted to the various parquet strip widths.

The adhesive strip 4 consists of two mutually complementary parts 4A and 4B, the two parts being interconnected by cheese-head screws 13. The adhesive delivery is determined and regulated by the size and number of the dispensing openings, the speed of travel and the system pressure.

The nozzle is let-in in the adhesive strip 4 and cannot fall out after the two-part adhesive strip has been screwed together. The adhesive strip is, with the nozzles, attached to the adhesive cylinder by means of a nut 12M.

The entire adhesive strip is coated with an adhesive-repellent plastic, for example with Teflon®. By virtue of this, the adhesive does not cling to the strip after setting and can easily be removed, by virtue of which the adhesive strip can be cleaned rapidly. In order that the adhesive strip does not touch the floor during use of the device and consequently the Teflon® layer is not damaged, rollers 15, which are attached to the strip via, for example, a deep-groove ball bearing, are located at both ends of the adhesive strip. The two adhesive cylinders are held together by two spectacle-type supports 17 and 18, which can be adapted to the various adhesive strips or exchanged according to adhesive strip type.

The two illustrative embodiments according to FIGS. 1 to 3 and 4 to 6 are operated by means of compressed air. The external compressed-air supply takes place via a supply hose 19, which is connected via a connection 20 to a handle 21, from which the internal compressed air is conducted to the various adhesive cylinders. The handle 21 is attached to the adhesive cylinder 2 by means of a clamping ring 22 and has a push-button valve 23, which is acted on by the external feed line 19 and can distribute the compressed air to the outgoing line 24 in a proportioned manner.

The line 24 leads to a distributor 25, in this case a double distributor, from which the compressed air is conveyed to the adhesive cylinders 2 and 3. A line 26 runs from the distributor 25 to the inlet of a quick-action ventilating valve 27. The quick-action ventilating valve 27 comprises a diaphragm 28, a diaphragm cover 29 and a tube cover 30. The valve with the inlet is attached to the adhesive cylinder by means of a tube nut 31.

The quick-action ventilating valve ensures that the pressure build-up in the adhesive cylinder is reduced very rapidly when the push-button valve is released. This prevents adhesive continuing to be pressed out of the adhesive strip. For safety reasons, the quick-action ventilating valve 27 is connected to the piston 6 via a cord connection in order to prevent the piston being ejected in the event of unintentional actuation of the push-button valve.

For filling of the adhesive cylinder, the piston is moved in the direction of the quick-action ventilating valve 27. After the adhesive bag has been introduced, the nut 12M is attached to the adhesive cylinder tube. The device is thus ready for use. Two sealing rings 32 and 33 can also be seen in the drawing.

FIG. 4 shows a dispensing device 34 which has a third adhesive cylinder 35 in addition to the two adhesive cylinders 2 and 3, the adhesive strip 36 accordingly having three nozzles 10 which end in the cavity 16, from which, however, in each case four ducts 37a, 37b, 37c and 37d branch off, the adhesive strip accordingly having three sets of four dispensing openings 38a, 38b, 38c and 38d. The adhesive strip has the same rollers 15 as the adhesive strip for two adhesive cylinders and the same construction.

The compressed-air supply takes place in the same way as in the first illustrative embodiment, the handle 31 being mounted on the central cylinder 2, and a triple distributor 38 being present instead of a double distributor 25, so that the compressed air is conducted both to the adhesive cylinder 2 and, via lines 26 and 57, to the other two adhesive cylinders 3 and 35. The functioning and the pistons etc. are identical to those of the first illustrative embodiment.

In the illustrative embodiment according to FIGS. 7 and 8, a variant embodiment is illustrated, in which no compressed air is required for dispensing the adhesive, but mechanical driving of the dispensing piston takes place. This has the advantage that a compressed-air line, which is not available everywhere, is not required and that attention does not have to be paid to a, frequently irritating, supply hose.

In a similar way to the device 1, the device 42 has two adhesive cylinders 43 and 44, which are interconnected via the same spectacle-type supports 17 and 18. The cylinder outlet 12 and the nozzles and in particular the adhesive strip are the same as in the first illustrative embodiment.

The adhesive is dispensed by means of a threaded rod 45, which is arranged between the two adhesive cylinders and is guided by bearings 46 and 47. The threaded rod can have a hexagon socket 48 at one of its ends, for example, so as to be driven by a device such as is found on a building site, for example a cordless drill. The bearing arrangements 46, 47 are ball bearing arrangements known per se and are not explained in detail here.

The threaded rod 45 is connected to the two pistons 52 via a nut piece 49 and a continuous piston connection 50. The piston connection is connected to the piston via a connecting piece 51, which is attached to the two-part piston 52. The piston 52 consists of a front part 53 and a guide 54 at a spacing, the connecting piece 51 being attached to both parts.

The front part of the piston is of the same design as in the previous illustrative embodiments in order to dispense the adhesive as completely as possible. The adhesive cylinder is closed at the top with a screw cover 55. In order to allow the movement of the piston connection, the adhesive cylinder tube 56 is slotted, as emerges from FIG. 7. For filling of the adhesive cylinder, the nut piece is, with the piston, drawn in the direction of the screw cover, after which the adhesive bags can be introduced and the adhesive strip can be attached by means of the nuts 12M.

Starting from this example with two adhesive cylinders, devices with more than two adhesive cylinders with a mechanical piston drive are also possible, the mechanical propulsion having to be adapted. The drive of the threaded rod or of a similar arrangement can also take place by means of drives other than cordless drills or the like, for example via an electric motor or the like, again preferably operated by batteries or rechargeable batteries.

Starting from the illustrative embodiments described above according to FIGS. 1-8, it can be seen that both devices with one adhesive cylinder and a correspondingly adapted adhesive strip and devices with more than three adhesive cylinders are possible, in each case the adhesive strip being made in a similar way and consisting of two parts and having two castors arranged on the two sides. It is a common feature of all adhesive strips that they are coated with an adhesive-repellent plastic in order for it to be possible to perform very rapid cleaning. The adhesive containers do not necessarily have to be adhesive cylinders; other shapes are also possible.

FIGS. 9 and 10 illustrate a further illustrative embodiment, which brings about considerable simplification. The adhesive strip 57 is connected to a device 58 which has three adhesive cylinders 59, 60 and 61, in a similar way to in the device 34, the same parts being provided with the same reference numbers and the other parts of the device being the same as those described previously.

Departing from the previous examples, the adhesive strip 57 is made in one piece from an adhesive-repellent plastic and has a continuous longitudinal duct 62, in which the outlets 63-65 of a transition piece 66 end, the longitudinal duct 62 serving as a cavity, from which outlet ducts 67 extend, which end in the dispensing openings 68.

As can be seen from FIG. 10, the housing 69 of the adhesive strip is not of symmetrical design in relation to the dispensing openings 68, as these are arranged above the apex of the tapering housing. In FIG. 10, “above” means the position in relation to the device when used on a floor. This ensures a better, more uniform adhesive flow.

The asymmetrical position of the dispensing openings is also advantageous for the adhesive strips 4 and 36 described previously.

The adhesive strip 57 has similar rollers 15 to those described previously, which are attached to a rectangular tube 70, which extends above the adhesive strip inlets. This allows the three transition pieces 66 with the funnel-shaped nozzles 9 and the outlets 63-65 and also the nuts 12M, which serve for receiving and attaching the adhesive cylinders 59-61 with the adhesive bags, to be attached thereto, which brings about a further simplification. The rectangular tube 70 is attached to the housing 69 by means of two lateral sheet-metal strips 71, which extend on the two sides. The rollers 15 are likewise attached to the lateral metal sheets 71, on the inside.

1. A device for dispensing adhesive, with at least one adhesive container with an application arrangement arranged at the container outlet, characterized in that the application arrangement comprises an adhesive strip which has a number of dispensing openings.

2. The device as claimed in claim 1, characterized in that a nozzle is arranged between each adhesive container outlet and the adhesive strip, which nozzle ends in the adhesive strip in a cavity, from where ducts lead to the dispensing openings.

3. The device as claimed in claim 2, characterized in that the adhesive strip has rollers arranged on both sides.

4. The device as claimed in claim 1, characterized in that the adhesive strip consists of two parts and is provided with a coating which repels adhesive.

5. The device as claimed in claim 4, characterized in that the coating consists of Teflon®.

6. The device as claimed in claim 1, characterized in that each adhesive container has a piston, the front part of which is adapted to the inlet of the nozzle.

7. The device as claimed in claim 1, characterized in that it has two or three adhesive containers, which are interconnected via spectacle-type supports.

8. The device as claimed in claim 1, characterized in that the pistons can be acted on with compressed air.

9. The device as claimed in claim 8, characterized in that the compressed air arrives at the piston via a push-button valve, a distributor and a quick-action ventilating valve.

10. The device as claimed in claim 1, characterized in that the pistons can be operated mechanically.

11. The device as claimed in claim 10, characterized in that the pistons can be operated by a driven threaded rod arranged between the adhesive cylinders, the threaded rod being connected to the pistons via a nut piece and piston connection.

12. The device as claimed in claim 10, characterized in that the adhesive cylinder tubes have a slot.

13. The device as claimed in claim 1, characterized in that the adhesive strip is made in one piece from adhesive-repellent plastic and has a continuous longitudinal duct, in which the outlets of the adhesive cylinders end and from which the outlet ducts to the dispensing openings of the adhesive strip extend.

14. The device as claimed in claim 13, characterized in that a rectangular tube is mounted on the housing of the adhesive strip, to which tube a transition piece is attached for each adhesive cylinder.

15. The device as claimed in claim 14, characterized in that the transition piece has a funnel-shaped nozzle, the outlet and a nut for attaching the adhesive cylinder.

16. The device as claimed in claim 1, characterized in that the dispensing openings are arranged asymmetrically in such a way in relation to the tapering end of the adhesive strip housing which faces the floor during use that they are located above the center.
